(19) United States
(12) Patent Application Publication
(10) Pub. No.: US 2016/0124932 A1
(43) Pub. Date: May 5, 2016

(54) DATA PROCESSING DEVICE AND METHOD

(71) Applicant: International Business Machines Corporation, ARMONK, NY (US)

(72) Inventors: Xiao Yan Chen, Beijing (CN); Yao Liang Chen, Beijing (CN); Sheng Liang Huang, Shanghai (CN); Kai Liu, Beijing (CN); Chen Wang, Beijing (CN); Wen Yi Xiao, SHANGHAI (CN); Xiao Min Xu, Beijing (CN)

(21) Appl. No.: 14/918,786

(22) Filed: Oct. 21, 2015

(30) Foreign Application Priority Data
Oct. 31, 2014 (CN) 201410602508.9

(51) Int. Cl. G06F 17/24; G06F 17/30

(52) U.S. Cl. CPC G06F 17/246; G06F 17/30427; G06F 17/30392; G06F 17/30554

(57) ABSTRACT

Data processing device and method. The device includes: a spreadsheet of data displaying row for displaying a part of data retrieved from a database and a hyper row for expressing the remaining data; a data processor configured to calculate the value of the formula based on the data retrieved from the database. According to the device and method of the present invention, it is possible to eliminate overhead for loading data from the database to the spreadsheet when there are massive data records, continuously update the resulting data, and minimize users' development and migration cost.

### CROSS-REFERENCE TO RELATED APPLICATION

This application claims the benefit of priority to Chinese Patent Application No. 201410602508.9, filed Oct. 31, 2014, the contents of which are incorporated herein by reference.

### BACKGROUND

The present invention relates to a spreadsheet and a database management system (DBMS), and more specifically, to a data processing method and device using a spreadsheet.

Currently, spreadsheets like Excel are the main tool for data analytics in the fields of for example energy, finance, accounting and so on. In many industries, data is generated continuously, but current spreadsheets are only applicable for processing static data. It has extremely low efficiency to perform process by a spreadsheet currently for big overhead to load a large amount of data from a DBMS. Especially, when for example more than a million data records exist in the spreadsheet, the data process is extremely slow. It is because data continuously comes to the DBMS, and thus when data changes, the user of the spreadsheet needs to re-run the entire data process completely even if only a small part of data is changed.

### SUMMARY

According to one aspect of the present invention, there is provided a data processing device including: a spreadsheet including a data displaying row for displaying a part of data retrieved from a database, and a hyper row for expressing data other than the part of data displayed in the data displaying row retrieved from the database; a data processor configured to, in response to creating a formula in the spreadsheet and the formula referring to at least one cell in the hyper row, calculate the value of the formula based on the data retrieved from the database.

According to another aspect of the present invention, there is provided data processing method including: providing a data displaying row for displaying a part of data retrieved from a database and a hyper row for expressing data other than the part of data displayed in the data displaying row retrieved from the database in a spreadsheet; in response to creating a formula in the spreadsheet and the formula referring to at least one cell in the hyper row, calculating the value of the formula based on the data retrieved from the database.

According to yet another aspect of the present invention, there is provided a non-transitory computer program product for data processing. The computer program product includes a storage medium which can be accessed by a computer and store instructions which are executed by the computer to perform each step of the data processing method provided by the above aspect of the present invention.

According to the device and the method of the present invention, it is possible to eliminate overhead for loading data from the database to the spreadsheet when there are massive data records, continuously update the resulting data in the spreadsheet for new incoming data, and minimize the users' development cost and migration cost for it is compatible with the software framework of current spreadsheets.

### BRIEF DESCRIPTION OF THE SEVERAL VIEWS OF THE DRAWINGS

Through the more detailed description of some embodiments of the present invention in the accompanying drawings, the above and other objects, features and advantages of the present invention will become more apparent, wherein the same reference generally refers to the same components in the embodiments of the present invention.

FIG. 1 shows an exemplary computer system/server 12 which is applicable to implement the embodiments of the present invention.

FIG. 2 shows a structural diagram of a data processing device according to an embodiment of the present invention.

FIG. 3 shows a schematic diagram of a spreadsheet according to an embodiment of the present invention.

FIG. 4 shows a schematic diagram of a spreadsheet according to another embodiment of the present invention.

FIG. 5 shows a structural diagram of a data processing device according to another embodiment of the present invention.

FIG. 6 shows an exemplary diagram of a database query condition according to an embodiment of the present invention.

FIG. 7 shows an exemplary diagram of a database query condition according to another embodiment of the present invention.

FIG. 8 shows a flowchart of a data processing method according to an embodiment of the present invention.

### DETAILED DESCRIPTION

Some preferable embodiments will be described in more detail with reference to the accompanying drawings, in which the preferable embodiments of the present invention have been illustrated. However, the present invention can be implemented in various manners, and thus should not be construed to be limited to the embodiments disclosed herein. On the contrary, those embodiments are provided for the thorough and complete understanding of the present invention, and completely conveying the scope of the present invention to those skilled in the art.

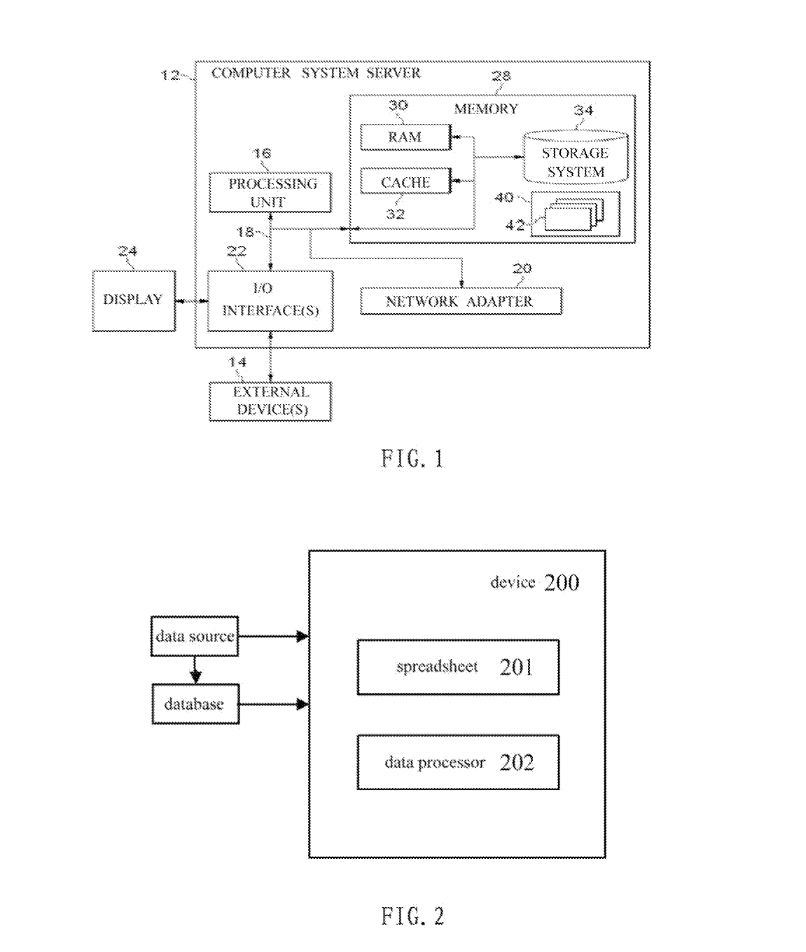

Referring now to FIG. 1, in which an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, at least one processor or processing units 16, a system memory 28, and a bus 18 that couples various system components including system memory 28 to processor 16.

Bus 18 represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by at least one data media interface. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, at least one application program, other program modules, and program data. Each of the operating system, at least one application program, other program modules, and program data or some combination thereof, may include an implementation of a networking environment. Program modules 42 generally carry out the functions and/or methodologies of embodiments of the invention as described herein.

Computer system/server 12 may also communicate with at least one external device 14 such as a keyboard, a pointing device, a display 24, etc.; at least one device that enables a user to interact with computer system/server 12; and/or any devices (e.g., network card, modem, etc.) that enable computer system/server 12 to communicate with at least one other computing device. Such communication can occur via Input/Output (I/O) interfaces 22. Still yet, computer system/server 12 can communicate with at least one network such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components can be used in conjunction with computer system/server 12. Examples, include, but are not limited to: microcode, device drivers, redundant processing units, external disk drive arrays, RAID systems, tape drives, and data archival storage systems, etc.

With reference now to the figures, specific implementations of the present invention are described in detail.

FIG. 2 is schematic structural diagram of a data processing device according to an embodiment of the present invention.

As shown in FIG. 2, data processing device 200 according to an embodiment of the present invention includes spreadsheet 201 and data processor 202. Here, the spreadsheet can be at least one spreadsheet of spreadsheet software, which are displayed on the display of device 200. Data processor 202 can be embodied by any processor running a software program or firming a software program into hardware.

According to an embodiment of the present invention, spreadsheet 201 includes a data displaying row for displaying a part of data retrieved from a database and a hyper row for expressing data other than the part of data displayed in the data displaying row retrieved from the database; data processor 202 is configured to, in response to creating a formula in spreadsheet 201 and the formula referring to at least one cell in the hyper row, calculate the value of the formula based on the data retrieved from the database. Here, according to an embodiment of the present invention, the above data retrieved from the database can be history data in the database, or new data from a data source.

According to one aspect of the present invention, the database herein can be any type of database, which can be located inside the data processing device 200 according to the embodiments of the present invention, or can be located outside the data processing device 200 and is communicatively connected to the data processing device 200. The data source generating the new data can be multiple, different data collecting devices, which can be located outside the data processing device 200 or inside the data processing device 200.

The data processing device 200 according to an embodiment of the present invention can be implemented by the computer system/server 12 as shown in FIG. 1.

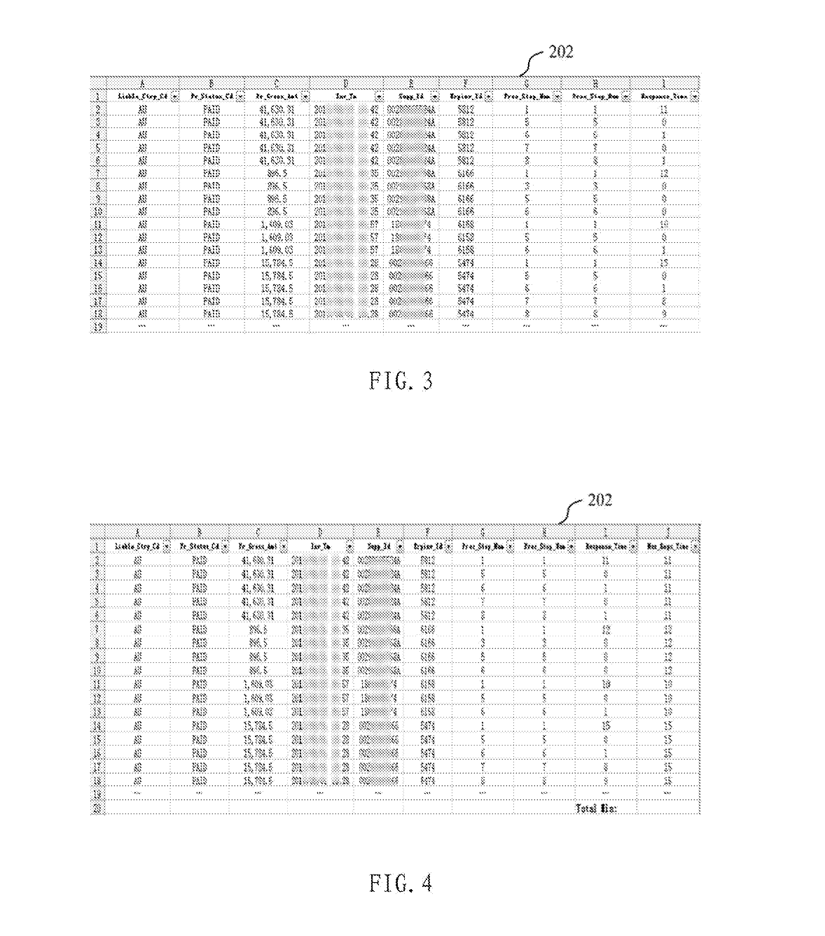

FIG. 3 is a schematic diagram showing a spreadsheet according to an embodiment of the present invention.

Since there may be millions or even billions of data records in a data base, it is very hard to display all the data in the spreadsheet, and the spreadsheet is only applicable to display a part of the data records. According to an embodiment of the present invention, other data records that cannot be displayed are expressed by hyper rows. According to an embodiment of the present invention, the spreadsheet can display the first “n” data records of the database in the data displaying rows of the spreadsheet while placing data records starting from the (n+1)th data record (including the (n+1)th data record) in the hyper row which is used to express these data records, where “n” is a natural number. According to an embodiment of the present invention, the hyper row can be inserted as the last row of the spreadsheet.

The example shown in FIG. 3 is that the layout of the spreadsheet displays data records in horizontal rows. The above example does not limit the scope of the present invention. When the spreadsheet displays data records in vertical rows, the hyper row also applies to the data records displayed in vertical rows.

According to an embodiment of the present invention, for example, the part of data displayed in the data displaying row of the spreadsheet 201 and the data expressed in the hyper row other than the part of data displayed in the data displaying row are obtained by executing a first database query.

Here, description is made by taking an accounting database management application processing invoices as an example. For example, for the spreadsheet, the following database query (for example but not limited to SQL) sentences (referred to as the first database query) can be determined:

select Liable_Ctry_Cd, Pr_Status_Cd, Pr_Gross_Amt, Inv_Tm, Supp_Id, Erpinv_Id, Proc_Step_Num, Proc_Step_Num, Response_Time from A a, B b where a.Erpinv_Id=b.Erpinv_Id and b.CTRYCODE IN (‘616’, ‘652’, ‘672’, ‘709’, ‘736’, ‘749’, ‘766’, ‘778’, ‘796’, ‘818’, ‘834’, ‘855’, ‘856’, ‘858’, ‘615’, ‘605’).

The above example is only exemplary, but not limiting of the scope of the present invention. The present invention can be described by any other examples.

The data processor (e.g., data processor 202 as shown in FIG. 2) parses, stores and executes the first database query. The first database query extracts the name and data of each field related to the processing procedure of payment and invoicing, and displays the name and data of each field in the spreadsheet (e.g., the spreadsheet 201 as shown in FIG. 2).

As shown in FIG. 3, the value of the above parameter “n” is set as for example 18, that is, the first 18 rows of the spreadsheet 201 is used for displaying the above field names and data of the database and the 19^{th} row is used as the hyper row for placing more massive data of the database. As such, data processor 202 executes the first database query in such a way that the field names and the first 17 data records of the database are loaded into a blank spreadsheet 201 firstly, and then the hyper row 19 is inserted at the end of the spreadsheet to place the data records starting from the 18^{th} data records of the database. After executing the above first database query, information shown in FIG. 3 can be displayed in the spreadsheet 201. As shown in FIG. 3, in the spreadsheet 201, the 19^{th} row is the hyper row, and the value of each cell of the hyper row is presented by “. . . ”, which represents all data records retrieved by executing the first database query other than the data records displayed in cells of the 2^{nd} to 18^{th} data displaying rows of the spreadsheet 201.

FIG. 4 is a schematic diagram showing a spreadsheet according to another embodiment of the present invention.

According to another embodiment of the present invention, a column J is newly added in the spreadsheet 201, of which the field name is Max_Resp_Time (maximum response time).

For example, the following formula is set in cell J2:

{=MAX(IF($F$2:$F$19=F2,$I$2:$I$19))} (1)

It is possible to automatically fill the above formula (1) into each cell of J3 to J19 by dragging the cursor from J2 to J19 through the automatic filling function of the spreadsheet, wherein cell J19 is in the hyper row.

According to an embodiment of the present invention, the above “formula” refers to an equation with a series of operations following “=” as the starting built in the cells of the spreadsheet.

The above formula (1) represents calculating the maximum value of the response time (Reponse_Time, in column I of the spreadsheet 201) under the condition that the values of the invoice ID (Erpinv_Id, in column F of the spreadsheet 201) are the same, and filling the maximum value in corresponding cells of column J corresponding to the invoice ID.

The specific form of the above formula and the type of calculation are only exemplary, which do not limit the scope of the present invention. The present invention can be exemplified by any other formulas.

If formula (1) is not filled into cell J19 but only filled into cells in J2 to J18, since the data of all cells in rows corresponding to J2 to J18 is displayed in the spreadsheet 201, the corresponding values of formula (1) can be calculated directly by using the values of data in related cells in column A to column I displayed in the spreadsheet 201.

For formula (1), there are two cases. In one case, multiple resulting values can be obtained within one cell after calculating the formula, and these resulting values cannot be displayed in one cell simultaneously. In this case, the formula can be referred to as “ambiguous formula”. For example, a formula is to output one result for each row of data (i.e., outputting multiple results for multiple rows), for example, it is to acquire all data records of the database and multiply them by 10 respectively. If there are a million data records in the database, a million results will be output, which cannot be displayed in one cell simultaneously. In another case, only one resulting value will be obtained by calculating the formula, and the one resulting value can be displayed in one cell. In this case, the formula can be referred to as “unambiguous formula”. For example, the formula is to output one result for multiple rows of data, for example, it is to output only a maximum value to a target cell. In conclusion, when the formula of a cell is to output multiple results, this formula is ambiguous; when the formula of a cell is to output one result, this formula is unambiguous.

If the formula constructed in the cell J19 of the hyper row is an unambiguous formula, it is possible to use two methods to calculate the value of the target cell J19. A first method is a history data update method according to an embodiment of the present invention, in which a new second database query is generated based on the initial first database query and the above equation (1), and the value of the target cell J19 is calculated by the second database query based on the history data of the database and/or new data from the data source. Another method is a real-time data update method according to an embodiment of the present invention, in which the value of the target cell J19 is calculated by using a formula result memory based on the new data from the data source.

If the formula constructed in the cell J19 of the hyper row is an ambiguous formula, according to an embodiment of the present invention, the cell can be highlighted or denoted as a different display color to indicate that the cell cannot achieve an unambiguous resulting value.

The formula result memory according to an embodiment of the present invention is a data storage structure, which will be described in detail below.

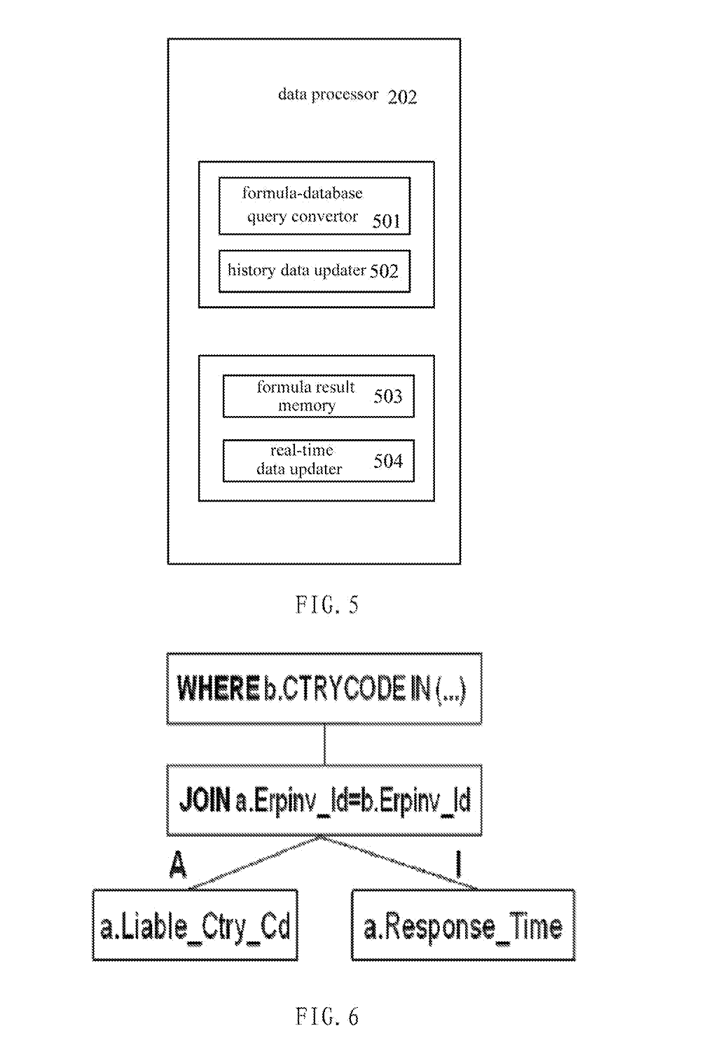

FIG. 5 is a schematic structural diagram of a data processor according to another embodiment of the present invention.

According to another embodiment of the present invention, data processor 202 can further include a formula-database query converter 501 and a history data updater 502, and a formula result memory 503 and a real-time data updater 504.

Formula-database query converter 501 is configured to generate a new database query (also referred to as a second database query) based on the formula (e.g., the above formula (1)) and the first database query. For example, but not limited to, the formula-database query converter 501 can be configured to modify the query condition (for example but not limited to being represented in the form of query tree) of the first database query according to the formula to obtain the query condition (for example but not limited to being represented in the form of query tree) of the second database query, thereby obtaining the second database query.

In particular, the formula can consist of various functions (for example but not limited to +, −, *, /, sum, max, et al) in the database. Therefore, it is possible to generate conversion related to database query conditions, for example, modify the first database query based on the above formula (1) to generate the second database query.

For example, by parsing the above database query “select Liable_Ctry_Cd, Pr_Status_Cd, Pr_Gross_Amt, Inv_Tm, Supp_Id, Erpinv_Id, Proc_Step_Num, Proc_Step_Num, Response_Time, where a.Erpinv_Id=b.Erpinv_Id and b.CTRYCODE IN (‘616’, ‘652’, ‘672’, ‘709’, ‘736’, ‘749’, ‘766’, ‘778’, ‘796’, ‘818’, ‘834’, ‘855’, ‘856’, ‘858’, ‘615’, ‘605’)”, the query condition of the first database query can be obtained.

FIG. 6 is an exemplary diagram of the query condition of the database query according to an embodiment of the present invention.

As shown in FIG. 6, two conditions are included in the above first database query, which are “WHERE b.CTRYCODE IN (‘616’, ‘652’, ‘672’, ‘709’, ‘736’, ‘749’, ‘766’, ‘778’, ‘796’, ‘818’, ‘834’, ‘855’, ‘856’, ‘858’, ‘615’, ‘605’)”, and “JOIN a.Erpinv_Id=b.Erpinv_Id”. The data satisfying the above two conditions in the database is displayed in column A “Liable_Ctry_Cd” to column I “Response_Time” of the spreadsheet 201.

As shown in the above FIG. 4, the column J is newly added in the spreadsheet 201, of which the field name is Max_Resp_Time (maximum response time). The user sets in for example the cell J2 the formula (1): {=MAX(IF($F$2:$F$19=F2,$I$2:$I$19))}, and fills this formula into cells J3 to J19 by using the automatic filling function of the spreadsheet, wherein cell J19 is in the hyper row.

The above formula is parsed, and the query condition of the first database query is modified based on the above formula (1).

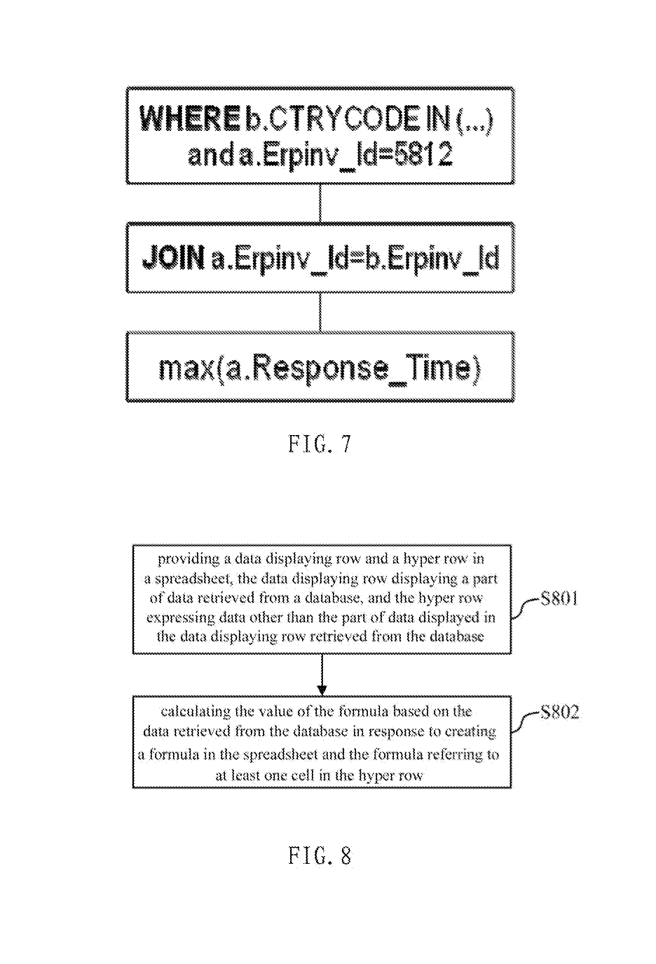

FIG. 7 is an exemplary diagram of the query condition of the database query according to another embodiment of the present invention.

As shown in FIG. 7, the query condition of the first database query is modified as a new query condition (the query condition of the second database query) based on the above formula (1). In the query condition of the second database query, the conditions “WHERE b.CTRYCODE IN ( . . . ) and a. Erpinv_Id=5812” and “JOIN a.Erpinv_Id=b.Erpinv_Id” are included. When the above conditions are satisfied, the maximum value of the response time “max(a.Response Time)” is output.

The history data updater 502 according to an embodiment of the present invention is configured to execute the second database query to calculate the values of the formula (1) in the corresponding cells based on the history data in the database (and/or the new data from the data source).

For example, the second database query is executed in the history data updater 502, that is,

SELECT max(Response Time) FROM A a, B b

WHERE a.Erpinv_Id=b.Erpinv_Id and b.CTRYCODE IN ( . . . ) and Erpinv_Id=5812.

Thereby, the maximum value of the response time is obtained by using the history data in the database.

With the same method as the above, it is possible to construct the following formula (2) in the cell J20 of the 20^{th} row of the spreadsheet 201 to obtain the minimum value among those maximum values:

B=MIN (J2:J19) (2)

The specific form of the above formula and the type of calculation are only exemplary, but do not limit the scope of the present invention. The present invention can be exemplified by any other formulas.

In the above, the formula-database query converter 501 and the history data updater 502 according to an embodiment of the present invention are described.

According to another embodiment of the present invention, when there are continuously updated data records, a real-time data process can be performed.

As shown in FIG. 5, data processor 202 can also include a formula result memory 503 and a real-time data updater 504.

Formula result memory 503 is configured to store the value of the formula. Real-time data updater 504 is configured to update the value of the formula by using the value calculated based on the new data, stored in formula result memory 503. The formula result memory is a data structure for storing (intermediate) calculation results of decomposable formulas. Thereby, it is possible to update and display the results of a formula in respective cells in real time.

The above decomposable formula (function) refers to such a function F( ) that when given two data sets “A” and “B”, if F(A UB) can be calculated from the results of F(A) and F(B), then the function F( ) is decomposable. For example, functions Min, Max, Sum, Count, Avg among others are decomposable. If all functions constituting a formula are decomposable, the formula is decomposable.

The continuous data processing by constructing a formula result memory mainly includes: constructing a formula result memory for storing results of decomposable, unambiguous formulas across multiple (at least one) spreadsheets; detecting whether a new data record is inserted to the database; checking whether the formula related to the new data record is decomposable; if the formula is decomposable, storing an intermediate calculation result of the formula in the formula result memory; updating the value of the related cell in the spreadsheet with the intermediate calculation result stored in the formula result memory.

If the formula is not decomposable, the calculation results based on real-time data cannot be stored in the formula result memory. In this case, the above history data updater executes the second database query to calculate the result of the formula in the cell based on the history data in the database and the new data newly coming to the database, and periodically update the value of the formula by invoking the calculated result.

According to another embodiment of the present invention, the real-time data updater is further configured to use the formula result memory to store the value of the formula calculated by the history data updater based on the history data as an initial value of the formula. For example, when there is real-time data and the formula result memory is used for processing, if the processing of the real-time data is related to the history data in the database, it is needed to firstly obtain an initial value of the formula by the history data updater based on the history data, and then calculate the value of the formula for the real-time data by the formula result memory based on the initial value. However, the calculation process based on the real-time data will not invoke the history data any more, but is only related to the initial value.

More specifically, the process of constructing a formula result memory to perform data update includes the following operations.

1. Collecting different conditions from functions of the spreadsheet and condition clauses of the database query sentences (e.g. SQL) to constitute a condition set. Here, functions of the spreadsheet 201 can for example be but not limited to IF, SUMIF and so on in Excel, and the condition clauses of SQL sentences can for example be WHERE clause or the like. In an embodiment of the present invention, the formula constructed in for example cell J2 is referred to as “formula J2”, and the condition corresponding to the formula J2 is referred to as “condition C(J2)”, and so on. In an embodiment of the present invention, multiple conditions can be extracted for the spreadsheet 201 as follows:

C(J2)˜C(J6)={CTRYCODE IN List1 and Erpinv_Id=5812}

C(J7)˜C(J10)={CTRYCODE IN List1 and Erpinv_Id=6166}

C(J11)˜C(J13)={CTRYCODE IN List1 and Erpinv_Id=6158}

C(J14)˜C(J18)={CTRYCODE IN List1 and Erpinv_Id=5474}

C(J20)={CTRYCODE IN List1}

Here, the condition is not extracted from J(19) since the formula J(19) is an ambiguous formula.

Wherein, “CTRYCODE IN List1” is extracted from a SQL sentence, “Erpinv_Id=5812, Erpinv_Id=6166, Erpinv_Id=6158 and Erpinv_Id=5474” are extracted from formulas or functions. In the above embodiment of the present invention, the formulas J2-J18 are all unambiguous formula, but the formula J19 is an ambiguous formula. Since the formula J20 (i.e. formula (2)) refers to the value of cell J19 in the hyper row, the formula J20 is also an ambiguous formula.

It is noted that, the formulas J2-J19 are all decomposable formulas, but the formula J20 is an indecomposable formula.

2. Partitioning the above condition set into multiple subsets, wherein conditions in each of the multiple subsets do not overlap each other, and adding an “else” condition in each subset. In other words, for any subset, given a data record, there is one but only one matched condition in the subset; if no condition matches the data record, then the “else” condition is used for match. For example, the condition set is partitioned into K subsets, and conditions in each subset do not overlap each other in terms of the data they refer to. Here, an example of condition overlapping is as follows. For example, the condition “name=Mike” can overlap the condition “age=18”, since a person named Mike can be 18 years old. However, generally, the condition “name=Mike” does not overlap the condition “name=John”, since a person named Mike cannot be named John. For example, in the above condition sets, the conditions C(J2), C(J7), C(J11) and C(J14) do not overlap each other, but there may be overlap between the condition C(J2) and the conditions C(J3)˜C(J6), C(J20), between C(J7) and C(J8)˜C(J10), C(J20), between C(J11)a and C(J12)˜C(J13). C(J20), between C(J14) and C(J15)˜C(J18), C(J20). Therefore, here, the condition set is partitioned into two subsets, and the condition “else” is added at the end of each subset, as follows:

P1={C(J2), C(J7), C(J11), C(J14), else}

P2={C(J20), else}

Here, in the above two partitioned subsets, for example C(J2) in P1={C(J2), C(J7), C(J11), C(J14), else} can be replaced by C(J3) because, in the example, the condition C(J2)=C(J3)=C(J4)=C(J5)=C(J6)={CTRYCODE IN List1 and Erpinv_Id=5812}, i.e., they are the same. Similarly, for other conditions C(J7), C(J11) and C(J14), the same replacement can be performed.

3. For each condition, associating the formulas of all conditions overlapping the condition with the condition. In subset P1, the association between the conditions and the formulas is as follows: C(J2): {J2˜J6, J20}; C(J7): {J7˜J10, J20}; C(J11): {J11˜J13, J20}; C(J14): {J14˜J18, J20}; else: {J20}.

In subset P2, the association between the condition and the formulas is as follows: C(J20): {J2˜J18, J20}; else: {}.

In the above associations, C(J2): {J2˜J6, J20} represents the condition C(J2) is associated with formulas J2, J3, J4, J5, J6 and J20, the conditions corresponding to the formulas J2, J3, J4, J5, J6 and J20 are C(J2), C(J3), C(J4), C(J5), C(J6) and C(J20) respectively, and the conditions C(J2), C(J3), C(J4), C(J5), C(J6) and C(J20) may overlap the C(J2). The meaning of other association expressions is the same as the above.

4.Creating an index for each subset, so that given a data record, the corresponding condition can be found in the subset. For example, the field Erpinv_Id is used to create an index for subset P1.

5.Storing the intermediate results of all decomposable, unambiguous formulas so that these intermediate results can be located and updated rapidly. For example, since the formulas J2˜J18 (i.e. formula (1)) are decomposable and unambiguous formulas, after calculating the results of the formulas J2˜J18, the formula result memory is used to store the results of the decomposable formula (1) as follows: Result(J2)=11; Result(J7)=12; Result(J11)=10; Result(J14)=15.

Since the formula J20 is indecomposable, in the real-time data updating according to an embodiment of the present invention, the formula J20 has no resulting value. In this case, the value of the target cell J20 can be periodically updated based on the history data in the database and the new data from a data source according to the history data updating method of an embodiment of the present invention. According to an embodiment of the present invention, the real-time data updater is configured to: for new data inserted into the database, look up the condition of the new data in each subset; obtain multiple formula sets associated with those conditions; calculate the intersection of the multiple formula sets; and update the value of each formula in the obtained intersection by using the formula result memory.

In particular, for each new data record inserted into the database in real time, the corresponding condition of the new data record in each subset is looked up by use of the index, and multiple formula sets associated with the above conditions are obtained. For example, there is new data coming into the database, and the new data is for example CTRYCODE=616, Erpinv_Id=5812, response_time=50. At this time, it is determined that CTRYCODE=616 is in the list1, and the corresponding conditions related to the above new data in each subset are looked up by the index Erpinv_Id=5812. Here, in the subset P1={C(J2), C(J7), C(J11), C(J14), else}, the related conditions found by use of the index Erpinv_Id=5812 of the new data are C(J2) and C(J20). According to the association between the above conditions and formulas, the formulas associated with the condition C(J2) are J2˜J6, J20, and the formulas associated with the condition C(J20) are J2˜J18, J20. Thereby, two formula sets {J2˜J6, J20} and {J2˜J18, J20} can be obtained.

The intersection of the above multiple formula sets is calculated to obtain one formula set. For example, the intersection of the above formula sets are calculated to obtain one formula set {J2, J3, J4, J5, J6, J20}. Then, the results of the formulas J2, J3, J4, J5 and J6 can be obtained by using the formula result memory, and these results are compared with the value “50” respectively.

If these results are smaller than the value “50”, the value of the formulas J2, J3, J4, J5 and J6 are updated to “50”; otherwise, no update is performed. Because the formula J20 is indecomposable, it cannot be updated in real time. According to an embodiment of the present invention, it is possible to change the display color of cell J20 in the spreadsheet to denote it as out-of-date data to indicate the J20 cannot update data in real time.

The display results of each cell J2, J3, J4, J5, J6 in the spreadsheet 201 is updated.

FIG. 8 is a flowchart showing a data processing method according to an embodiment of the present invention.

As shown in FIG. 8, in step S801, a data displaying row for displaying a part of data retrieved from a database and a hyper row for expressing data other than the part of data displayed in the data displaying row retrieved from the database are provided in a spreadsheet. In step S802, in response to creating a formula in the spreadsheet and the formula referring to at least one cell in the hyper row, the value of the formula is calculated based on the data retrieved from the database.

According to an embodiment of the present invention, the data retrieved from the database includes at least one of history data and new data from a data source.

According to an embodiment of the present invention, in the above method, the part of data displayed in the data displaying row and the data expressed in the hyper row other than the part of data displayed in the data displaying row are obtained by executing a first database query.

According to an embodiment of the present invention, the above method further includes a step of modifying the first database query based on the formula to generate a second database query.

According to an embodiment of the present invention, the above method further includes a step of executing the second database query to calculate the value of the formula based on at least one of the history data and the new data.

According to an embodiment of the present invention, the above method further includes a step of constructing a formula result memory to store the value of the formula.

According to an embodiment of the present invention, the above method further includes a step of updating the value of the formula by using the value calculated based on the new data, stored in the formula result memory.

According to an embodiment of the present invention, the above method further includes a step of using the formula result memory to store the value of the formula calculated based on the history data as an initial value of the formula.

According to an embodiment of the present invention, the step of constructing a formula result memory includes: collecting different conditions from functions of the spreadsheet and condition clauses of database query sentences to constitute a condition set; partitioning the condition set into multiple subsets, wherein conditions in each of the multiple subsets do not overlap each other; for each condition, associating the formulas of all conditions overlapping the condition with the condition; and creating an index for each subset, so that given a data record, the overlapped condition can be fast found in the subset.

According to an embodiment of the present invention, the step of updating the value of the formula including: looking up the condition of the new data in each subset by using the index; obtaining multiple formula sets associated with those conditions; calculating the intersection of the multiple formula sets; and updating the value of each formula in the obtained intersection by using the formula result memory.

The device and method for analyzing data by using a spreadsheet according to the embodiments of the present invention are described in details in the above.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of at least one programming language, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which includes at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. A data processing device comprising:
a spreadsheet comprising a data displaying row for displaying a part of data retrieved from a database and a hyper row for expressing data other than the part of data displayed in the data displaying row retrieved from the database; and
a data processor configured to calculate the value of the formula based on the data retrieved from the database in response to creating a formula in the spreadsheet and the formula referring to at least one cell in the hyper row.

2. The device of claim 1, wherein the data retrieved from the database comprises at least one of history data and new data from a data source.

3. The device of claim 2, wherein the part of data displayed in the data displaying row and the data expressed in the hyper row other than the part of data displayed in the data displaying row are obtained by executing a first database query.

4. The device of claim 3, wherein the data processor comprises:
a formula-database query converter configured to modify the first database query based on the formula to generate a second database query.

5. The device of claim 4, wherein the data processor comprises:
a history data updater configured to execute the second database query to periodically update the value of the formula by using the value calculated based on at least one of the history data and the new data.

6. The device of claim 5, wherein the data processor comprises:
a formula result memory configured to store the value of the formula.

7. The device of claim 6, wherein the data processor comprises:
a real-time data updater configured to update the value of the formula by using the value calculated based on the new data, stored in the formula result memory.

8. The device of claim 7, wherein the real-time data updater is further configured to use the formula result memory to store the value of the formula calculated by the history data updater based on the history data as an initial value of the formula.

9. The device of claim 6, wherein the formula result memory is constructed in the following:
collecting different conditions from functions of the spreadsheet and condition clauses of database query sentences to constitute a condition set; partitioning the condition set into multiple subsets, wherein conditions in each of the multiple subsets do not overlap each other; for each condition, associating the formulas of all conditions overlapping the condition with the condition; and
creating an index for each subset, so that given a data record, the overlapped condition is fast found in the subset.

10. The device of claim 7, wherein the real-time data updater is further configured to:
look up the condition of the new data in each subset by using the index; obtain multiple formula sets associated with those conditions; calculate the intersection of the multiple formula sets; and update the value of each formula in the obtained intersection by using the formula result memory.

11. A data processing method comprising:
providing a data displaying row for displaying a part of data retrieved from a database and a hyper row for expressing data other than the part of data displayed in the data displaying row retrieved from the database in a spreadsheet; and
calculating the value of the formula based on the data retrieved from the database in response to creating a formula in the spreadsheet and the formula referring to at least one cell in the hyper row.

12. The method of claim 11, wherein the data retrieved from the database comprises at least one of history data and new data from a data source.

13. The method of claim 11, wherein the part of data displayed in the data displaying row and the data expressed in the hyper row other than the part of data displayed in the data displaying row are obtained by executing a first database query.

14. The method of claim 12, further comprising a step of modifying the first database query based on the formula to generate a second database query.

15. The method of claim 14, further comprising a step of executing the second database query to calculate the value of the formula based on at least one of the history data and the new data.

16. The method of claim 15, further comprising a step of constructing a formula result memory to store the value of the formula.

17. The method of claim 16, further comprising a step of updating the value of the formula by using the value calculated based on the new data stored in the formula result memory.

18. The method of claim 17, further comprising a step of using the formula result memory to store the value of the formula, calculated based on the history data as an initial value of the formula.

19. The method of claim 16, wherein the step of constructing a formula result memory comprises:
collecting different conditions from functions of the spreadsheet and condition clauses of database query sentences to constitute a condition set;
partitioning the condition set into multiple subsets, wherein conditions in each of the multiple subsets do not overlap each other;
for each condition, associating the formulas of all conditions overlapping the condition with the condition; and
creating an index for each subset, so that given a data record, the overlapped condition is fast found in the subset.

20. The method of claim 17, wherein the step of updating the value of the formula comprises:
looking up the condition of the new data in each subset by using the index; obtaining multiple formula sets associated with those conditions;
calculate the intersection of the multiple formula sets; and
updating the value of each formula in the obtained intersection by using the formula result memory.

21. A non-transitory computer program product for data processing including a storage medium accessible by a computer device having store computer readable instructions which, when executed, causes the computer to carry out the steps of the method according to claim 11.
